(19) United States
(12) Patent Application Publication
(10) Pub. No.: US 2003/0096919 A1
(43) Pub. Date: May 22, 2003

(54) Silicone wax

(75) Inventor: Shoji Ichinohe, Tokyo (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: Shin-Etsu Chemical Co., Ltd., Tokyo (JP)

(21) Appl. No.: 10/295,999

(22) Filed: Nov. 18, 2002

(30) Foreign Application Priority Data
Nov. 16, 2001 (JP) 2001-351576

(51) Int. Cl. C08G 77/00

(52) U.S. Cl. 525/474

(57) ABSTRACT

A silicone wax which has a melting point of 45° C. or more, and an endothermic peak half value amplitude in a scanning differential calorimeter measurement of 7° C. or less is disclosed. This silicone wax is easily obtained by a reaction between the reaction product of a higher fatty acid of purity 90% or higher, and/or a higher alcohol of purity 90% or higher and a double bond-containing compound, and one or more compounds chosen from among a SiH bond-containing silicone compound, an amino group-containing silicone compound and a sulfhydryl group-containing compound, or by a dehydration reaction between a higher fatty acid of purity 90% or higher and an amino group-containing silicone compound.

### FIELD OF THE INVENTION

This invention relates to a high purity silicone wax, in particular, to a silicone wax having a relatively high melting point of 45° C. or more, and a sharp endothermic peak on a differential scanning calorimetry (DSC) chart, and to a method of manufacturing this silicone wax.

### BACKGROUND OF THE INVENTION

In recent years, with the higher speeds in PPC copying machines and printers, demand for offset performance of toner has become higher. To meet this demand, in the prior art, silicone wax was added to toner. In this case, as it is necessary not only to increase the speed of toner transfer but also obtain high image resolution, it was required that this silicone wax had a relatively high melting point.

Silicone wax was conventionally obtained by the hydrosilylation reaction of an alpha olefin, the unsaturated ester of a higher fatty acid, the unsaturated ether of a higher alcohol and a SiH bond-containing silicone compound. However, although the polymer alpha olefin has a high melting point, it has a wide molecular weight distribution, so the corresponding silicone wax did not have a sharp melting point. In a higher fatty acid unsaturated ester-addition silicone wax, a sharp melting point was obtained by increasing the purity of the higher fatty acid used, but when stearic acid, etc., was used, the melting point fell below 45° C. Further, even when a higher alcohol unsaturated ether was used, if stearyl alcohol was used, a product with a melting point of 45° C. or more could not be obtained. Likewise, in the case where a higher fatty acid and an aminosilicone were reacted together, excepting when high purity behenic acid was used, a silicone wax having a relatively high melting point and a sharp endothermic peak in DSC could not be obtained. A silicone wax suitable for addition to toner which could be developed at low cost, was therefore desired.

The Inventor carried out intensive studies aimed at producing a silicone wax having a relatively high melting point of 45° C. or more and a sharp endothermic peak in DSC. As a result, it was discovered that a wax containing double bonds could be obtained by reacting a high purity, higher fatty acid and/more on high purity, higher alcohol with a compound containing double bonds. The desired silicone wax was then obtained by making this wax undergo an addition reaction with an SiH bond-containing silicone or a Michael addition with an aminosilicone and/or sulfhydrylsilicone, or by performing a dehydration reaction between behenic acid of purity 90% or more, and an aminosilicone having an amino group as functional group.

It is therefore a first object of this invention to provide, at low cost, a silicone wax suitable for addition to toner having a melting point of 45° C. or higher and a DSC measurement peak half value amplitude of 7° C. or less, which could not be obtained in the prior art.

It is a second object of this invention to provide a method of manufacturing a silicone wax having a melting point of 45° C. or higher and a DSC measurement peak half value amplitude of 7° C. or less.

### SUMMARY OF THE INVENTION

The above object of this invention are attained by a silicone wax obtained by reaction between the reaction product of a higher fatty acid and/or a higher alcohol with a double bond-containing compound, and at least one compound selected from among a SiH bond-containing silicone compound, amino group-containing silicone compound and a sulfhydryl group-containing silicone compound, or by a dehydration reaction between a higher fatty acid and an amino group-containing silicone compound, the melting point of the silicone wax being 45° C. or more, and the endothermic main peak half value amplitude being 7° C. or less, and by a method of manufacturing this silicone wax.

### DETAILED DESCRIPTION OF THE INVENTION

The starting material for the silicone wax of this invention is selected from among a higher fatty acid and higher alcohol of purity 90% or more on, but it is preferred that it has a high melting point and high purity. In this invention, stearic acid, stearyl alcohol, behenic acid and behenyl alcohol of purity 90% or more can be used, but behenic acid and behenyl alcohol are particularly preferred.

In this invention, when an addition reaction is used, a compound for silicone addition is obtained by reacting the aforesaid higher fatty acid and higher alcohol with a double bond-containing compound. The following are examples of this compound.

BAOCH₂CH═CH₂, BAO(CH₂)₉CH═CH₂, BA′OCH₂CH═CH₂, BA′O(CH₂)₉CH═CH₂, BAOCH₂CH(OH)CH₂OCH₂CH═CH₂, and BAO(HO)□CH═CH₂, BAOCH₂CH(OBA)CH₂OCH₂CH═CH₂, BA′OCH₂CH(OBA′)CH₂OCH₂CH═CH₂, BA′OCO(CH₂)₈CH═CH₂, (BAOCH₂)₂C₃H₅CH₂OCH₂CH═CH₂, (BA′OCH₂)₂C₃H₅CH₂OCH₂CH═CH₂, BA′OCOCH₂C(═CH₂)COOBA′ (I)

STOCH₂CH(OST)CH₂OCH₂CH═CH₂, ST′OCH₂CH(OST′)CH₂OCH₂CH═CH₂, (STOCH₂)₂C₃H₅CH₂OCH₂CH═CH₂, (ST′OCH₂)₂C₃H₅CH₂OCH₂CH═CH₂, ST′OCOCH₂C(═CH₂)COOST′ (II).

Here, BA is C₂₁H₄₃C═O, BA′ is C₂₂H₄₅, ST is C₁₇H₃₅C═O, ST′ is C₁₈H₃₇, and □ is a vinyl cyclohexene epoxide residue.

All these compounds are introduced into the silicone wax by a hydrosilylation reaction.

(I) and (II) may be introduced into the silicone wax by a Michael addition reaction. The silicone wax thus obtained has a melting point of 45° C. or more, and a main peak half value amplitude in DSC of 7° C. or less. When the melting point of the silicone wax is less than 45° C., it causes the toner to aggregate when added to toner and storage stability becomes poor. And if the endothermic main peak half value amplitude exceeds 7° C., when the silicone wax is dissolved in styrene-acrylic monomer to manufacture a styrene acrylic toner by suspension polymerization, the molecular weight distribution of the toner produced is too wide, and the non-offset region of the toner is too narrow. Further, even if the silicone wax is added to a polyester toner by the crushing method, the non-offset region of the toner is still too narrow. From the viewpoint of structural control, it is preferred that the silicone used in the above addition reaction comprises a hydrosilyl group, amino group or sulfhydryl group at both ends or only one end, and the silicone used may also have functional groups in the side chain.

The reaction of the SiH-bond containing hydrogen silicone and double bond-containing compound is performed by a known method without a solvent or in a solvent using a platinum catalyst. The reaction temperature is 30° C.-150° C., but it is particularly preferred that it is within the range of 60° C.-120° C.

Regarding the molar ratio between the hydrogen silicone and the double bond-containing compound, the double bond-containing compound is usually in excess, i.e., 1.05-1.2 moles, but the invention is not limited thereto.

The Michael addition reaction between the double bond-containing compound and aminosilicone and/or sulfhydryl silicone is carried out without a catalyst or in the presence of an amine or phosphine catalyst, under identical conditions to the above, and the reaction molar ratio is also identical.

The dehydration reaction between a higher fatty acids such as high purity behenic acid and the amino group-containing silicone such as an aminosilicone having an aminopropyl group at one end or both ends, may also be easily carried out under the conditions known in the art.

### EXAMPLES

Hereafter, this invention will be described in further detail by specific examples, but it should be understood that the invention is not limited thereby.

### Example 1

1707 g (2.2 moles) of glycerol monoallyl ether dibehenate [BAOCH₂CH(OBA)CH₂OCH₂ CH═CH₂] derived from the reaction of 92% pure behenic acid and glycerol monoallyl ether, an identical amount of toluene and 5 g of neutral tetramethyldivinyl disiloxane complex of chloroplatinic acid (0.5% toluene solution) were placed in a flask, and 726 g (1.0 moles) of a hydrogen siloxane having the average structural formula HMe₂SiO(Me₂SiO)₈SiMe₂H was dripped in at 80° C. Next, a reaction was performed under reflux of toluene for 5 hours, and the solvent was removed by stripping to obtain 2310 g of the silicone wax (I) (yield 95%).

### Example 2

A reaction was performed in an identical manner to that of Example 1, except that instead of the 1707 g (2.2 moles) of glycerol monoallyl ether dibehenate used in Example 1, 1729 g (2.2 moles) of trimethylolpropane monoallyl ether dibehenate [(BAOCH₂)₂C₃H₅CH₂OCH₂CH═CH₂] derived from the reaction of 92% pure behenic acid and trimethylolpropane monoallyl ether was used. 2360 g of the silicone wax (II) was obtained (yield 96%).

For the synthesis of trimethylolpropane monoallyl ether dibehenate, 92% pure behenic acid was used.

In the synthesis of all the compounds in the examples, 92% pure behenic acid or behenyl alcohol was used.

### Example 3

A reaction was performed in an identical manner to that of Example 1, except that instead of the 1707 g (2.2 moles) of glycerol monoallyl ether dibehenate used in Example 1, 1132 g (2.3 moles) of undecylenic acid behenyl trimethylolpropane monoallyl ether dibehenate [BA′OCO(CH₂)₈CH═CH₂] derived from the reaction of 98% pure undecylenic acid and behenyl alcohol was used. 1780 g of the silicone wax (III) was obtained (yield 96%).

### Example 4

A reaction was performed in an identical manner to that of Example 1, except that instead of the 1707 g (2.2 moles) of glycerol monoallyl ether dibehenate used in Example 1, 1021 g (2.2 moles) of the reaction product of behenic acid and vinylcyclohexane epoxide reaction product [BAO(HO)□CH═CH₂] was used. 1660 g of the silicone wax (IV) was obtained (yield 95%).

### Example 5

A dehydration condensation reaction was performed between 680 g (2.0 moles) of behenic acid and 841 g (1.0 mole) of a two-end amino-modified silicone having the average structural formula H₂NC₃H₆Me₂SiO(Me₂SiO)₈Si Me₂C₃H₆NH₂ in 680 g of xylene for 5 hours, and the solvent was removed by stripping. 1440 g of the silicone wax (V) was obtained (yield 97%).

### Example 6

A reaction was performed between 1641 g (2.2 moles) of itaconic acid dibehenyl derived from the reaction of behenyl alcohol having the formula BA′OCOCH₂C(═CH)COOBA′ (I) and itaconic acid, and 841 g (1.0 mole) of a two-end amino-modified silicone having the average structural formula H₂NC₃H₆Me₂SiO(Me₂SiO)₈SiMe₂C₃H₆NH₂ in 800 g of xylene at 130° C. for 5 hours, and the solvent was removed by stripping. 2360 g of the silicone wax (VI) was obtained (yield 95%).

### Example 7

A reaction was performed between 1641 g (2.2 moles) of itaconic acid dibehenyl and 875 g (1.0 mole) of a two-end sulfhydryl-modified silicone having the average structural formula HSC₃H₆Me₂SiO(Me₂SiO)₈SiMe₂C₃H₆SH in 800 g of xylene in the presence of 1 g of triphenylphosphene as catalyst at 130° C. for 5 hours, and the solvent was removed by stripping. 2440 g of the silicone wax (VII) was obtained (yield 97%).

### Comparative Example 1

A reaction was performed in an identical manner to that of Example 1, except that a glycerol monoallyl ether dibehenate was synthesized from the reaction of 82% purity behenic acid (impurity was stearic acid) instead of the 92% purity behenic acid used in Example 1, and glycerol monoallyl ether. The reaction was performed in an identical manner to that of Example 1, and 2310 g of the silicone wax (#) was obtained (yield 95%).

### Comparative Example 2

Instead of the 1707 g (2.2 moles) of glycerol monoallyl ether dibehenate used in Example 1, 924 g (2.2 moles) of the alpha-olefin having the average structural formula C₃₀H₆₀ (Dialene 30, Mitsubishi Chemicals Ltd,) was used. Apart from this, an identical procedure to that of Example 1 was followed, and 1570 g of the silicone wax (* [symbol] c) was obtained (yield 95%).

For the silicone waxes obtained in the Examples and Comparative Examples, the temperature was raised from −100° C. by 10° C. per minute, and DSC measurement was performed. The results as shown in Table 1.

TABLE 1

| | | DSC endothermic | Endothermic peak |
|---|---|---|---|
| | Silicone wax | peak value | half value amplitude |
| Example | (I) | 54° C. | 6° C. |
| | (II) | 47° C. | 4° C. |
| | (III) | 45° C. | 4° C. |
| | (IV) | 45° C. | 5° C. |
| | (V) | 74° C. | 3° C. |
| | (VI) | 56° C. | 7° C. |
| | (VII) | 57° C. | 6° C. |
| Comparetive | (#) | 53° C. | 9° C. |
| Example | (*) | 61° C. | 15° C. |

The DSC endothermic peak values in the Table are the temperatures at the tip of the endothermic peak, and the endothermic peak half value amplitude was read by drawing a parallel line to the temperature scale at the point which is ½ of the height of the endothermic peak, and reading the temperature amplitude between the two points intersecting the peak.

The results of Table 1 show the effectiveness of the present invention.

What is claimed is:

1. A silicone wax obtained by a reaction between the reaction product of a higher fatty acid and/or a higher alcohol and a double bond-containing compound, and one or more compounds chosen from among a SiH bond-containing silicone compound, an amino group-containing silicone compound and a sulfhydryl group-containing compound, or by a dehydration reaction between a higher fatty acid and an amino group-containing silicone compound, whereof the melting point is 45° C. or more, and the half value amplitude of the endothermic main peak in differential scanning calorimetry is 7° C. or less.

2. The silicone wax according to claim 1, wherein the higher fatty acid is behenic acid and the higher alcohol is behenyl alcohol.

3. The method of manufacturing a silicone wax according to claim 1, wherein a hydrosilylation reaction is performed between the reaction product of a higher fatty acid of purity 90% or more and/or a higher alcohol of purity 90% or more, and the SiH bond-containing silicone compound, or a Michael addition reaction is performed between an amino group-containing silicone compound and/or a sulfhydryl group-containing compound, or a dehydration reaction is performed between a higher fatty acid of purity 90% or more and an amino group-containing silicone compound.

4. The method of manufacturing a silicone wax according to claim 3, wherein the reaction product of the higher fatty acid and/or higher alcohol, and the double bond-containing compound, is an unsaturated ester of a higher fatty acid, the ester of an unsaturated dicarboxylic acid or the unsaturated ether of a higher alcohol.

5. The method of manufacturing a silicone wax according to claim 4, wherein the unsaturated ester of a higher fatty acid, the ester of an unsaturated carboxylic acid or the unsaturated ether of a higher alcohol is a compound having two or more higher fatty acid residues or two or more higher alcohol residues in one molecule.

6. The method of manufacturing a silicone wax as disclosed in any of claims 3, wherein the higher fatty acid is behenic acid and the higher alcohol is behenyl alcohol.
